(19) United States
(12) Patent Application Publication
(10) Pub. No.: US 2014/0184556 A1
(43) Pub. Date: Jul. 3, 2014

(54) TOUCH SENSING APPARATUS AND TOUCH SENSING METHOD

(71) Applicant: SAMSUNG ELECTRO-MECHANICS CO., LTD., Suwon (KR)

(72) Inventors: Byeong Hak JO, Suwon (KR); Yong II Kwon, Suwon (KR); Moon Suk Jeong, Suwon (KR); Tah Joon Park, Suwon (KR); Kang Joo Kim, Suwon (KR); Hyun Suk Lee, Suwon (KR)

(73) Assignee: Samsung Electro-Mechanics Co., Ltd., Suwon (KR)

(21) Appl. No.: 13/795,406

(22) Filed: Mar. 12, 2013

(30) Foreign Application Priority Data
Dec. 28, 2012 (KR) 10-2012-0156848

(51) Int. Cl. G06F 3/041; G06F 3/044

(52) U.S. Cl. CPC G06F 3/0416; G06F 3/044
USPC 345/174

(57) ABSTRACT

There are provided a touch sensing apparatus and a touch sensing method. The touch sensing apparatus includes: a panel unit including a plurality of driving electrodes and a plurality of sensing electrodes; a driving circuit unit applying driving signals to the plurality of driving electrodes, respectively; a sensing circuit unit measuring a change in capacitance of node capacitors generated in intersections of the plurality of the driving electrodes and the plurality of sensing electrodes; a signal conversion unit generating a first digital signal based on the change in capacitance; and a calculation unit determining a touch according to the first digital signal, wherein the driving circuit unit and the sensing circuit unit are operated by an input voltage, and the signal conversion unit and the calculation unit are operated by a low voltage drop out (LDO) voltage generated by decreasing the input voltage.

### CROSS-REFERENCE TO RELATED APPLICATIONS

This application claims the priority of Korean Patent Application No. 10-2012-0156848 filed on Dec. 28, 2012, in the Korean Intellectual Property Office, the disclosure of which is incorporated herein by reference.

### BACKGROUND OF THE INVENTION

1. Field of the Invention

The present invention relates to a touch sensing apparatus and a touch sensing method for reducing power consumption by reducing an overall volume and consumed currents.

2. Description of the Related Art

A touch sensing apparatus such as a touchscreen, a touch pad, or the like, is an input device attached to a display device to provide an intuitive data input method to a user. Recently, a touch sensing apparatus has been widely applied to various electronic devices such as cellular phones, personal digital assistants (PDAs), navigation devices, and the like. In particular, recently, as demand for smartphones has increased, an employment rate of touchscreens as touch sensing apparatuses capable of providing various input methods in a limited area is on the rise.

Touchscreens employed in portable devices may be classified as resistive-type touchscreens and capacitive-type touchscreens according to a method of sensing a touch utilized thereby. Among these, capacitive touchscreens, having advantages in terms of relatively long lifespans and various easily implementable data input methods, has been increasingly applied. In particular, the capacitive touchscreen, facilitating implementation of a multi-touch interface relative to the resistive touchscreen, is extensively employed in devices such as smartphones, and the like.

The capacitive touchscreen includes a plurality of electrodes having a predetermined pattern, and a plurality of nodes in which capacitance is changed by a touch are defined by the plurality of electrodes. The plurality of nodes distributed on a two-dimensional (2D) plane generate changes in self-capacitance or in mutual-capacitance according to a touch applied thereto, and coordinates of a touch may be calculated by applying a weighted average calculation method, or the like, to the change in capacitance generated in the plurality of nodes.

Recently, as touch screen devices have been reduced in weight and thickness, a technology of reducing an overall volume and consumption power of touch screen devices have been developed multilaterally.

Patent document 1, the related art document below, relates to a capacitive touch panel and a capacitive touch system including the same, in which an undesired touch operation is interrupted by selectively activating a plurality of sub-touch panels to thus minimize power consumption, but without disclosing content of reducing an amount of LDO regulators generally employed in a touch screen.

### RELATED ART DOCUMENT

(Patent document 1) Korean Patent Laid Open Publication No. 10-2010-0073546

### SUMMARY OF THE INVENTION

An aspect of the present invention provides a touch sensing method and a touch sensing apparatus in which the amount of LDO regulators is reduced, thus reducing a volume otherwise occupied by the LDO regulators is reduced and lowering a current consumed by the LDO regulators to result in a reduction in power consumption.

According to an aspect of the present invention, there is provided a touch sensing apparatus including: a panel unit including a plurality of driving electrodes and a plurality of sensing electrodes; a driving circuit unit applying driving signals to the plurality of driving electrodes, respectively; a sensing circuit unit measuring a change in capacitance of node capacitors generated in intersections of the plurality of the driving electrodes and the plurality of sensing electrodes; a signal conversion unit generating a first digital signal based on the change in capacitance; and a calculation unit determining a touch according to the first digital signal, wherein the driving circuit unit and the sensing circuit unit are operated by an input voltage, and the signal conversion unit and the calculation unit are operated by a low voltage drop out (LDO) voltage generated by decreasing the input voltage.

The touch sensing apparatus may further include: a comparison unit comparing the input voltage and the LDO voltage to generate a second digital signal.

The touch sensing apparatus may further include an LDO regulator generating the LDO voltage upon receiving the input voltage.

The comparison unit may include: a plurality of series resistors dividing the LDO voltage; and a plurality of comparators comparing a plurality of divided voltages output from connection nodes of the plurality of respective series resistors with the input voltage to generate the second digital signal.

The touch sensing apparatus may further include an operational amplifier having an inverting terminal, an output terminal connected to the inverting terminal, and a non-inverting terminal to which the LDO voltage is applied, wherein the plurality of series resistors may divide an output voltage provided from the output terminal of the operational amplifier.

The calculation unit may compare the second digital signal with a pre-set data table to generate an estimated voltage level of the input voltage, and control a gain of the sensing circuit unit according to the estimated voltage level.

The sensing circuit unit may include at least one capacitor for measuring a change in capacitance, and the calculation unit may adjust capacitance of the at least one capacitor according to the estimated voltage level.

The calculation unit may determine at least one of the amount of touches, coordinates of touches, and a touch gesture (or a touch movement) according to the first digital signal.

According to another aspect of the present invention, there is provided a touch sensing method of the foregoing touch sensing apparatus, including: comparing the input voltage and the LDO voltage to generate a second digital signal; comparing the second digital signal with a pre-set data table to calculate an estimated voltage level of the input voltage; and controlling a gain of the sensing circuit unit according to the estimated voltage level of the input voltage.

In the generating of the second digital signal, the second digital signal may be generated by comparing the input voltage with each of the plurality of divided voltages generated from the LDO voltage.

In the controlling of a gain of the sensing circuit unit, capacitance of at least one capacitor included in the sensing circuit unit may be controlled.

The method may further include: determining a touch, after the controlling of the gain of the sensing circuit unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the exterior of an electronic device including a touch sensing apparatus according to an embodiment of the present invention;

FIG. 2 is a view illustrating a panel unit that may be included in the touch sensing apparatus according to an embodiment of the present invention;

FIG. 3 is a cross-sectional view of the panel unit illustrated in FIG. 2;

FIG. 4 is a circuit diagram of the touch sensing apparatus according to an embodiment of the present invention;

FIG. 5 is a circuit diagram of a comparison unit that may be included in the touch sensing apparatus according to an embodiment of the present invention;

FIG. 6 is a view illustrating output signals of the comparison unit that may be included in the touch sensing apparatus according to an embodiment of the present invention;

FIG. 7 is a flow chart illustrating a touch sensing method according to an embodiment of the present invention; and

FIG. 8 is a graph showing simulation data of the touch sensing apparatus according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

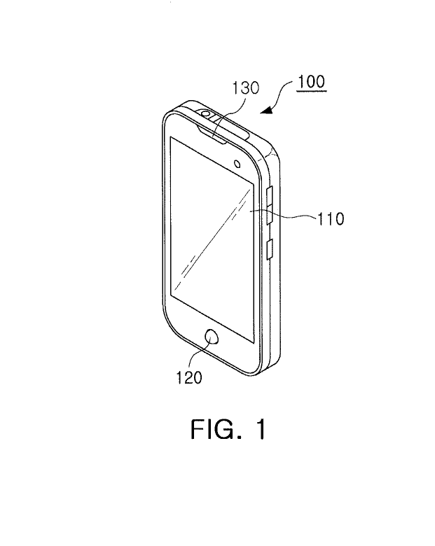

FIG. 1 is a perspective view illustrating the exterior of an electronic device including a touch sensing apparatus according to an embodiment of the present invention.

Referring to FIG. 1, an electronic device 100 according to the present embodiment may include a display unit 110 for outputting a screen, an input unit 120, an audio output unit 130 for outputting audio, and the like, and also, a touch sensing apparatus integrated with the display unit 110.

As illustrated in FIG. 1, in case of the mobile device, in general, a touch sensing apparatus is integrated with the display unit, and the touch sensing apparatus is required to have sufficient light transmittance to allow an image displayed on the display unit to be transmitted therethrough. Thus, the touch sensing apparatus may be implemented by forming a sensing electrode with a material such as indium tin oxide (ITO), indium zinc oxide (IZO), zinc oxide (ZnO), carbon nanotubes (CNT), or graphene having electrical conductivity on a base substrate made of a transparent film material such as polyethylene terephthalate (PET), polycarbonate (PC), polyethersulfone (PES), polyimide (PI), or the like. A wiring pattern connected to the sensing electrode made of a transparent conductive material is disposed in a bezel region of the display unit, and since the wiring pattern is visually shielded by the bezel region, the wiring pattern may also be made of a metal such as silver (Ag), copper (Cu), or the like.

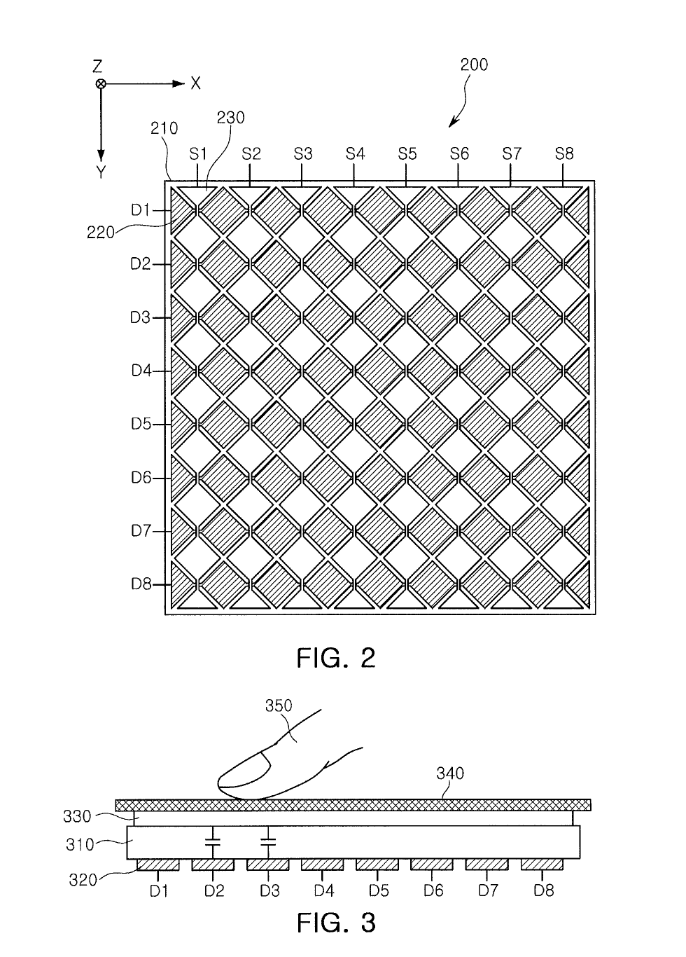

The touch sensing apparatus according to an embodiment of the present invention is assumed to operate according to a capacitive scheme, so it may include a plurality of electrodes having a predetermined pattern. Also, the touch sensing apparatus according to an embodiment of the present invention may include a capacitance sensing circuit detecting a change in capacitance generated by a plurality of electrodes, an analog-to-digital conversion circuit converting an output signal from the capacitance sensing circuit into a digital value, a calculation circuit determining a touch by using data which has been converted into the digital value, and the like. Hereinafter, the touch sensing apparatus and an operating method thereof according to an embodiment of the present invention will be described with reference to FIGS. 2 through 5.

FIG. 2 is a view illustrating a panel unit that may be included in the touch sensing apparatus according to an embodiment of the present invention.

Referring to FIG. 2, a panel unit 200 according to the present embodiment includes a substrate 210 and a plurality of electrodes 220 and 230 provided on the substrate 210. Although not shown, the plurality of electrodes 220 and 230 may be electrically connected to a wiring pattern of a circuit board attached to one end of the substrate 210 through a wiring and a bonding pad, respectively. A controller integrated circuit (IC) may be mounted on the circuit board to detect sensing signals generated by the plurality of electrodes 220 and 230 and determine a touch from the sensing signals.

In the case of the touchscreen device, the substrate 210 may be a transparent substrate on which the electrodes 220 and 230 are formed, and may be made of a plastic material such as polyimide (PI), polymethylmethacrylate (PMMA), polyethyleneterephthalate (PET), polycarbonate (PC), or tempered glass. Besides a region in which the electrodes 220 and 230 are formed, a predetermined printed region for visually shielding a wiring generally made of an opaque metal may be formed on the substrate 210 with respect to a region in which the wiring connected to the electrodes 220 and 230 is provided.

The plurality of electrodes 220 and 230 may be formed on one surface of the substrate 210 or on both surfaces thereof. The touchscreen device may be made of ITO, IZO, ZnO, CNT, a graphene material, or the like, which has transparency and conductivity. In FIG. 2, the electrodes 220 and 230 having a diamond-like pattern are illustrated, but the present invention is not limited thereto and the electrodes 220 and 230 may also have various polygonal patterns such as a rectangular pattern, a triangular pattern, or the like.

The plurality of electrodes 220 and 230 include first electrodes 220 extending in an X-axial direction and second electrodes 230 extending in a Y-axial direction. The first electrodes 220 and the second electrodes 230 may be formed on both surfaces of the substrate 210 or may be alternately formed on mutually different substrates 210. In the case in which both the first electrodes 220 and the second electrodes 230 are formed on one surface of the substrate 210, a predetermined insulating layer may be partially formed in intersections between the first electrodes 220 and the second electrodes 230.

The touch sensing apparatus, electrically connected to the plurality of electrodes 220 and 230 to sense a touch, may detect a change in capacitance generated in the plurality of electrodes 220 and 230 according to a touch applied thereto, and sense the touch based on the detected change in capacitance. The first electrodes 220 may be connected to channels defined as D1 to D8 in the control IC to receive a predetermined driving signal, and the second electrode 230 may be connected to channels defined as S1 to S8 so as to be used for the touch sensing apparatus to detect a sensing signal. Here, the controller IC may detect a change in mutual capacitance generated between the first electrodes 220 and the second electrodes 230, as a sensing signal, and operate to sequentially apply a driving signal to the respective first electrodes 220 and simultaneously detect a change in capacitance in the second electrodes 230.

FIG. 3 is a cross-sectional view of the panel unit illustrated in FIG. 2.

FIG. 3 is a cross-sectional view of the panel unit 200 illustrated in FIG. 2, taken along a plane Y-Z, which may further include a cover lens 340 receiving a contact in addition to the substrate 310 and the plurality of sensing electrodes 320 and 330 as described above with reference to FIG. 2. The cover lens 340 may be disposed on the second electrodes 330 used for detecting a sensing signal and receive a touch from a contact object 350 such as a finger, or the like.

When a driving signal is sequentially applied to the first electrodes 320 through the channels D1 to D8, mutual capacitance is generated between the first electrodes 320 to which the driving signal is applied and the second electrodes 330. When a driving signal is sequentially applied to the first electrodes 320, mutual capacitance generated between the first electrodes 320 and the second electrodes 330 adjacent to a region with which the contact object 350 came into contact is changed. The change in capacitance may be proportional to an area of an overlap region between the first electrodes 320 to which the driving signal has been applied and the second electrodes 330 and the contact object 350. In FIG. 3, mutual capacitance generated between the first electrodes 320 and the second electrodes 330 connected to the channels D2 and D3 is affected by the contact object 350.

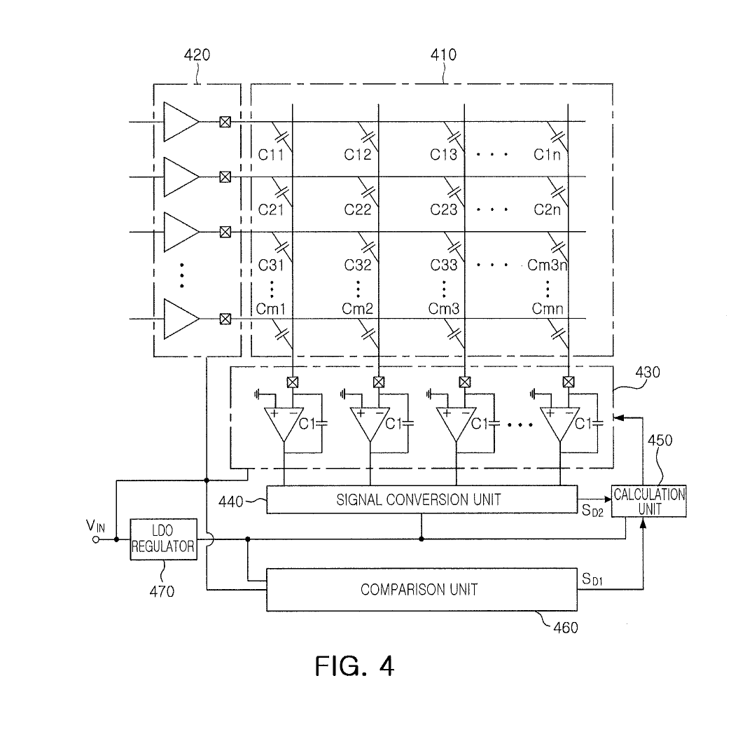

FIG. 4 is a circuit diagram of the touch sensing apparatus according to an embodiment of the present invention.

Referring to FIG. 4, the touch sensing apparatus according to an embodiment of the present invention includes a panel unit 410, a driving circuit unit 420, a sensing circuit unit 430, a signal conversion unit 440, and a calculation unit 450. In addition, the touch sensing apparatus according to the present embodiment may further include a comparison unit 460 and an LDO regulator 470.

The panel unit 410 includes m number of first electrodes extending in a first axial direction (or a horizontal direction in FIG. 4) and n number of second electrodes extending in a second axial direction (or a vertical direction in FIG. 4) crossing the first axis. Capacitance changes are generated in a plurality of nodes in which the first electrodes and the second electrodes intersect. The capacitance changes generated in the plurality of nodes may be changes in mutual capacitance generated by a driving signal applied to the first electrodes by the driving circuit unit 420. C11 to Cmn may correspond to node capacitors equivalently expressing capacitance components formed by the first electrodes and the second electrodes, and electrical charges may be charged to or discharged from the node capacitors C11 to Cmn according to a change in capacitance generated in the plurality of nodes. Meanwhile, the driving circuit unit 420, the sensing circuit unit 430, the signal conversion unit 440, and the calculation unit 450 may be implemented as a single integrated circuit (IC).

The driving circuit unit 420 applies a predetermined driving signal to the first electrodes of the panel unit 410. The driving signal may have a square wave form, a sine wave form, a triangle wave form, or the like, having a predetermined period and amplitude, and may be sequentially applied to the plurality of respective first electrodes. In FIG. 4, circuits for generating and applying driving signals are individually connected to the plurality of respective first electrodes, but the present invention is not limited thereto and it may be configured such that a single driving signal generation circuit is provided and a driving signal may be applied to a plurality of respective first electrodes by using a switching circuit.

The sensing circuit unit 430 may include an integrating circuit for sensing the capacitance changes C11 to Cmn generated in the plurality of nodes. The integrating circuit may be connected to the plurality of second electrodes. The integrating circuit may include at least one operational amplifier and a capacitor C1 having a certain capacity. An inverting input terminal of the operational amplifier is connected to the second electrode to convert capacitance changes C11 to Cmn into an analog signal such as a voltage signal, or the like, and output the same. When driving signals are sequentially applied to the plurality of respective first electrodes, capacitance changes from the plurality of second electrodes may be simultaneously detected, so n number of integrating circuits corresponding to the second electrodes may be provided.

The signal conversion unit 440 generates a digital signal S_{D} from the analog signal generated by the integrating circuit. For example, the signal conversion unit 440 may include a time-to-digital converter (TDC) circuit measuring a time during which an analog signal in a voltage form output by the sensing circuit unit 430 reaches a predetermined reference voltage level and converting the same into a first digital signal S_{D1}, or may include an analog-to-digital converter (ADC) circuit measuring an amount by which a level of an analog signal output by the sensing circuit unit 430 changes for a predetermined time and converting the same into a first digital signal S_{D1}.

The calculation unit 450 may determine a touch applied to the panel unit 310 by using the digital signal S_{D}. In an embodiment of the present invention, the calculation unit 450 may determine a number of touches applied to the panel unit 410, coordinates of a touch, a gesture, or the like. The digital signal S_{D} used as a reference for the calculation unit 450 to determine a touch may be data obtained by digitizing the capacitance changes C11 to Cmn, and in particular, it may be data indicating a difference of capacitance between a case in which a touch has not been generated and a case in which a touch has been generated. In general, in a touch sensing apparatus based on a capacitance scheme, a region in which a conductive object is in contact has reduced capacitance relative to a region in which a touch has not been applied.

As described above, the driving circuit unit 420, the sensing circuit unit 430, the signal conversion unit 440, and the calculation unit 450 may be implemented as a single integrated circuit (IC). In general, the IC is driven by a low voltage drop out (LDO) voltage output from an LDO regulator. Here, in generally, three LDOs regulators are provided in the touch sensing apparatus in order to drive the driving circuit unit 420, the sensing circuit unit 430, the signal conversion unit 440, and the calculation unit 450.

In the case of the digital blocks such as the signal conversion unit 440 and the calculation unit 450, the use of an input voltage V_{IN}, generally 2.7V to 3.6V, transferred from the outside, may cause a problem in reliability of a transistor, so the LDO voltage V_{LDO} is essential. Also, in the case of the analog blocks such as the driving circuit unit 420 and the sensing circuit unit 430, in a case in which they are operated with the LDO voltage VLDO, circuit designing is facilitated and a stable operation is guaranteed, so the LDO voltage V_{LDO}, rather than the input voltage V_{IN} transferred from the outside, is applied thereto

However, the LDO regulator has a large chip size and is disadvantageous in power consumption due to a voltage drop thereof, so there is a need to reduce the amount of the LDO regulators provided in the touch sensing apparatus.

In the touch sensing apparatus according to an embodiment of the present invention, LDO regulators for driving the driving circuit unit 420 and the sensing circuit unit 430 are eliminated, so that the driving circuit unit 420 and the sensing circuit unit 430 are operated by the input voltage VIN transferred from the outside and the signal conversion unit 440 and the calculation unit 450 are operated by the LDO voltage V_{LDO} output from the LDO regulator 470 illustrated in FIG. 4. The LDO regulator 470 reduces a voltage level of the input voltage V_{IN} transferred from the outside to generate an LDO voltage.

In this case, however, the input voltage V_{IN} transferred from the outside is varied generally within a range of 2.7V to 3.6V, so when the sensing circuit unit 430 is operated by the input voltage V_{IN}, an output voltage output from the sensing circuit unit 430 may fluctuate. In order to solve this problem, the comparison unit 460 is provided in the touch sensing apparatus according to an embodiment of the present invention and the calculation unit 460 estimates a voltage level of the input voltage V_{IN} according to a signal output from the comparison unit 460 to control a gain of the sensing circuit unit 430.

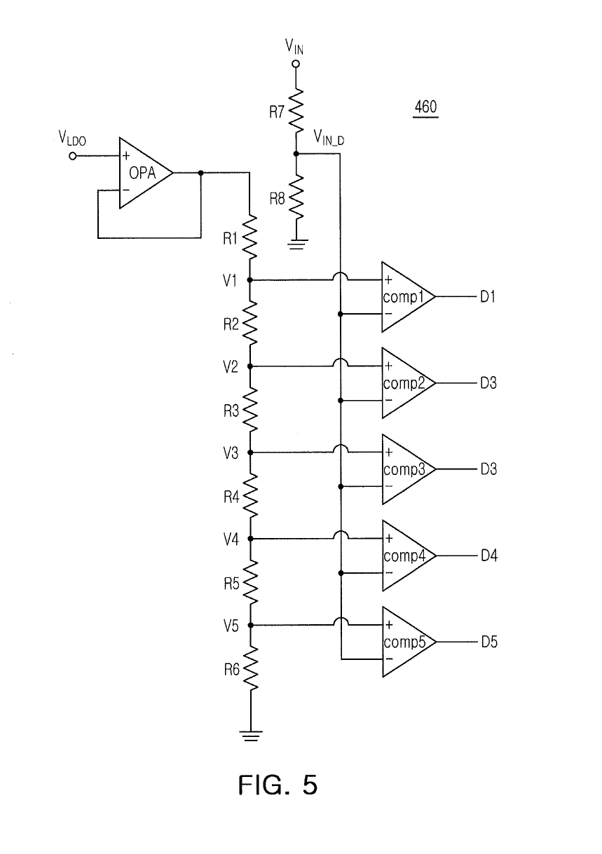

FIG. 5 is a circuit diagram of the comparison unit that may be included in the touch sensing apparatus according to an embodiment of the present invention. An operation of the circuit unit 460 will be described with reference to FIGS. 4 and 5. The comparison unit 460 may include a plurality of series resistors R1 to R6 and a plurality of comparators comp1 to comp5. In addition, the comparison unit 460 may further include an operational amplifier OPA.

The plurality of series resistors R1 to R6 divide the LDO voltage V_{LDO}. The LDO voltage V_{LDO} is divided by the plurality of series resistors R1 to R6, so divided voltages V1 to V5 having a level lower than that of the LDO voltage V_{LDO} are induced to the respective connection nodes of the plurality of series resistors R1 to R6.

The plurality of comparators comp1 to comp5 receive a plurality of divided voltages V1 to V5 output from the respective connection nodes of the plurality of series resistors R1 to R6 by non-inverting terminals thereof, and receive an input voltage V_{IN}_{_{—}}_{D} divided by resistors R7 and R8 by inverting terminals thereof, and generate a plurality of output signals D1 to D5. The plurality of output signals D1 to D5 are transferred as second digital signals S_{D2} to the calculation unit 450.

The plurality of series resistors R1 to R6 may directly receive the LDO voltage V_{LDO} and divide the received LDO voltage V_{LDO}, or may receive the LDO voltage V_{LDO} from an output terminal of an operational amplifier OPA and divide the same. The operational amplifier OPA may receive the LDO voltage V_{LDO} in a non-inverting terminal thereof, and an inverting terminal thereof may be connected to the output terminal thereof. Namely, the operational amplifier OPA may operate as a buffer to provide the LDO voltage V_{LDO} to the plurality of series resistors R1 to R6.

The comparison unit 460 consumes a current of approximately 0.3 mA, while the LDO regulator consumes a current of approximately 0.5 mA. Thus, in the case of employing the comparison unit 460, while eliminating the LDO regulator, a consumed current can be lowered to increase power efficiency.

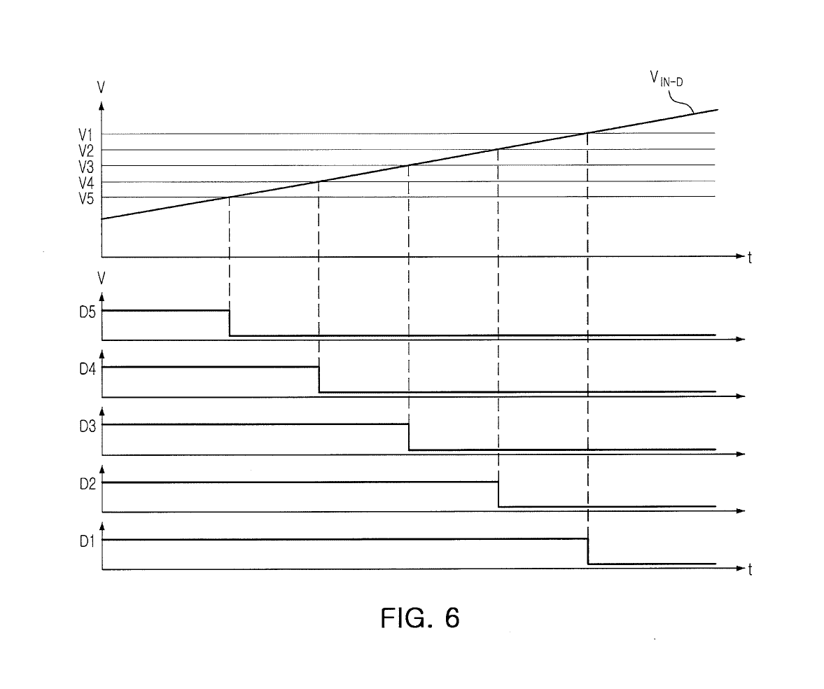

FIG. 6 is a view illustrating output signals of the comparison unit that may be included in the touch sensing apparatus according to an embodiment of the present invention. In the following description, a data set of signals output from the plurality of comparators comp1 to comp5 will be referred to as D1, D2, D3, D4, and D5.

A first graph of FIG. 6 shows a divided input voltage V_{IN}_{_{—}}_{D} and a plurality of divided voltages V1 to V5. The voltage V_{IN} input from the outside has a variable range, and thus, the divided input voltage V_{IN}_{_{—}}_{D} also has a variable range. In the first graph of FIG. 6, it is assumed that the V_{IN}_{_{—}}_{D} has a voltage level rising over time. A second graph of FIG. 6 shows a plurality of output signals D1 to D5 output from the plurality of comparators comp1 to comp5. In the following description, it is assumed that an output signal having a high level is 1 and an output signal having a low level is 0.

In a case in which the divided input voltage is lower than the voltage V5, (1, 1, 1, 1, 1) is generated. In a case in which the divided input voltage is equal to or higher than the voltage V5 and lower than the voltage V4, (0, 1, 1, 1, 1) is generated. In a case in which the divided input voltage is equal to or higher than the voltage V4 and lower than a voltage V3, (0, 0, 1, 1, 1) is generated. In a case in which the divided input voltage is equal to or higher than the voltage V3 and lower than a voltage V2, (0, 0, 0, 1, 1) is generated. In a case in which the divided input voltage is equal to or higher than the voltage V2 and lower than a voltage V1, (0, 0, 0, 0, 1) is generated. In a case in which the divided input voltage is higher than a voltage V1, (0, 0, 0, 0, 0) is generated.

Referring back to FIG. 4, the calculation unit 460 receives the data set of (D1,D2,D3,D4,D5) as a second digital signal S_{D2}, and compares the second digital signal with a pre-set data table to estimate a voltage level of the input voltage. For example, on the assumption that a variable range of the input voltage is 2.5V to 4V, the calculation unit 450 may compare the second digital signal S_{D2} with a data table shown in Table 1 to estimate a maximum voltage Vmax and a minimum voltage Vmin of the input voltage.

TABLE 1

| D1 | D2 | D3 | D4 | D5 | Vmin | Vmax |
|---|---|---|---|---|---|---|
| 1 | 1 | 1 | 1 | 1 | 2.5 | 2.78 |
| 1 | 1 | 1 | 1 | 0 | 2.78 | 2.99 |
| 1 | 1 | 1 | 0 | 0 | 2.99 | 3.21 |
| 1 | 1 | 0 | 0 | 0 | 3.21 | 3.38 |
| 1 | 0 | 0 | 0 | 0 | 3.38 | 3.62 |
| 0 | 0 | 0 | 0 | 0 | 3.62 | 4 |

According to the estimated voltage level of the input voltage, the calculation unit 460 controls a gain of the sensing circuit unit 430 to maintain a uniform voltage level output from the sensing circuit unit 430. In detail, by adjusting capacitance of at least one capacitor C1 provided to measure a change in capacitance generated in intersections of a plurality of electrodes of the panel unit 410, the calculation unit 450 may maintain a uniform voltage level output from the sensing circuit unit 430.

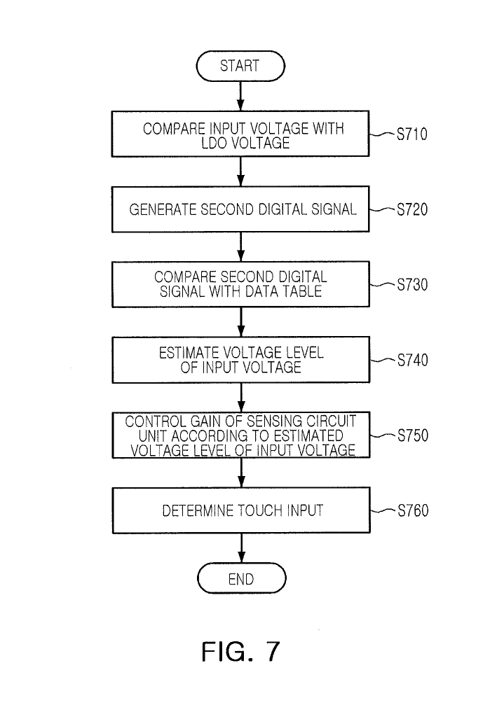

FIG. 7 is a flow chart illustrating a touch sensing method according to an embodiment of the present invention. A touch sensing method of the touch sensing apparatus will be described with reference to FIGS. 4, 5, and 7. The comparison unit 460 compares the input voltage V_{IN} and the LDO voltage V_{LDO} (5710). In detail, the comparison unit 460 may compare the divided input voltage V_{IN}_{_{—}}_{D} and the plurality of divided voltages V1 to V5 generated by dividing the LDO voltage V_{LDO} by the plurality of series resistors R1 to R6 to generate the second digital signal S_{D2} (S720). The calculation unit 450 compares the second digital signal S_{D2} with the pre-set data table (S730) to estimate a voltage level of the input voltage (S740). The calculation unit 460 controls a gain of the sensing circuit unit 430 according to the estimated voltage level of the input voltage (S750). In this case, the calculation unit 450 may adjust capacitance of at least one capacitor, provided in the sensing circuit unit 430, for detecting a change in capacitance to control a gain of the sensing circuit unit 430. After adjusting a gain of the sensing circuit unit 430, the calculation unit 450 may determine a touch (S760).

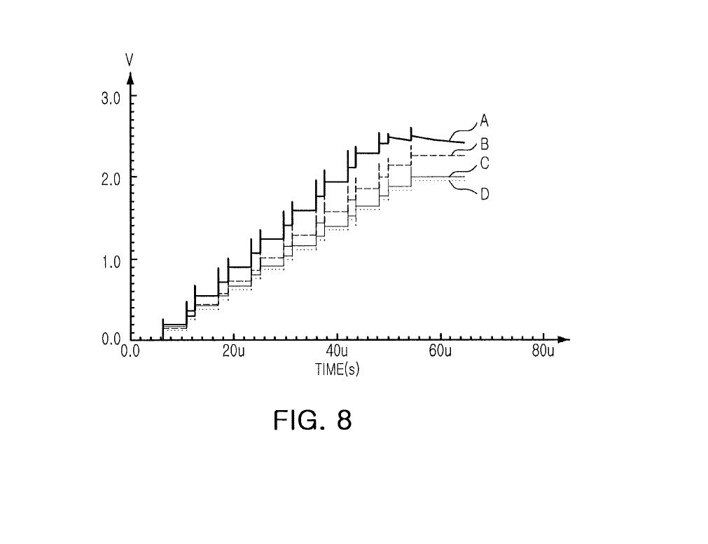

FIG. 8 is a graph showing simulation data of the touch sensing apparatus according to an embodiment of the present invention. Specifically, FIG. 8 is a graph showing output voltages of the sensing circuit unit 430 over time. With reference to FIGS. 4 and 8, A and B are graphs in a case in which an input voltage of 3.6V and an input voltage of 2.7V directly operate the sensing circuit unit, C is a graph in a case in which the calculation unit 4560 controls a gain of the sensing circuit unit 430 in the touch sensing apparatus according to an embodiment of the present invention, and D is a graph in a case in which the sensing circuit unit 430 is operated by an LDO voltage in the touch sensing apparatus according to an embodiment of the present invention.

It can be seen that, in 60 us, A has 2.45V, B has 2.25V, C has 1.976V, and D has 1.946V, so in the case of A and B, output voltages of the sensing circuit unit are fluctuated according to fluctuation of an input voltage, but in the case of C and D having a deviation of approximately 30 mV, uniform output voltages are output from the sensing circuit unit in spite of the fluctuation of the input voltage.

As set forth above, according to embodiments of the invention, by reducing the amount of LDO regulators, a volume occupied by the LDO regulators can be reduced accordingly, and a current consumed by the LDO regulators can be lowered to reduce power consumption.

While the present invention has been shown and described in connection with the embodiments, it will be apparent to those skilled in the art that modifications and variations can be made without departing from the spirit and scope of the invention as defined by the appended claims.

What is claimed is:

1. A touch sensing apparatus comprising:
a panel unit including a plurality of driving electrodes and a plurality of sensing electrodes;
a driving circuit unit applying driving signals to the plurality of driving electrodes, respectively;
a sensing circuit unit measuring a change in capacitance of node capacitors generated in intersections of the plurality of the driving electrodes and the plurality of sensing electrodes;
a signal conversion unit generating a first digital signal based on the change in capacitance; and
a calculation unit determining a touch according to the first digital signal,
wherein the driving circuit unit and the sensing circuit unit are operated by an input voltage, and the signal conversion unit and the calculation unit are operated by a low voltage drop out (LDO) voltage generated by decreasing the input voltage.

2. The touch sensing apparatus of claim 1, further comprising: a comparison unit comparing the input voltage and the LDO voltage to generate a second digital signal.

3. The touch sensing apparatus of claim 1, further comprising: an LDO regulator generating the LDO voltage upon receiving the input voltage.

4. The touch sensing apparatus of claim 2, wherein the comparison unit comprises:
a plurality of series resistors dividing the LDO voltage; and
a plurality of comparators comparing a plurality of divided voltages output from connection nodes of the plurality of respective series resistors with the input voltage to generate the second digital signal.

5. The touch sensing apparatus of claim 4, further comprising: an operational amplifier having an inverting terminal, an output terminal connected to the inverting terminal, and a non-inverting terminal to which the LDO voltage is applied,
wherein the plurality of series resistors divide an output voltage provided from the output terminal of the operational amplifier.

6. The touch sensing apparatus of claim 2, wherein the calculation unit compares the second digital signal with a pre-set data table to generate an estimated voltage level of the input voltage, and controls a gain of the sensing circuit unit according to the estimated voltage level.

7. The touch sensing apparatus of claim 6, wherein the sensing circuit unit includes at least one capacitor for measuring a change in capacitance, and the calculation unit adjusts capacitance of the at least one capacitor according to the estimated voltage level.

8. The touch sensing apparatus of claim 1, wherein the calculation unit determines at least one of the amount of touches, coordinates of touches, and a touch gesture according to the first digital signal.

9. A touch sensing method of the touch sensing apparatus according to claim 1, the method comprising:
comparing the input voltage and the LDO voltage to generate a second digital signal;
comparing the second digital signal with a pre-set data table to calculate an estimated voltage level of the input voltage; and
controlling a gain of the sensing circuit unit according to the estimated voltage level of the input voltage.

10. The method of claim 9, wherein in the generating of the second digital signal, the second digital signal is generated by comparing the input voltage with each of the plurality of divided voltages generated from the LDO voltage.

11. The method of claim 9, wherein in the controlling of a gain of the sensing circuit unit, capacitance of at least one capacitor included in the sensing circuit unit is controlled.

12. The method of claim 9, further comprising:
determining a touch, after the controlling of the gain of the sensing circuit unit.
